(19) United States
(12) Patent Application Publication
(10) Pub. No.: US 2013/0075499 A1
(43) Pub. Date: Mar. 28, 2013

(54) NOZZLE FOR A BURNER BOOM WATER SPRAY SYSTEM OF AN OFFSHORE PLANT

(71) Applicants: Hong-Woo JEON, Busan (KR); Hang-Bum Cho, Gimhae-si (KR); Do-Kyeong Lee, Busan (KR); Tae-Uk Heo, Yangsan-si (KR); Jin-Ho Ryu, Busan (KR)

(72) Inventors: Hong-Woo JEON, Busan (KR); Hang-Bum Cho, Gimhae-si (KR); Do-Kyeong Lee, Busan (KR); Tae-Uk Heo, Yangsan-si (KR); Jin-Ho Ryu, Busan (KR)

(73) Assignee: SEBO TECH CO., LTD., Busan (KR)

(21) Appl. No.: 13/586,713

(22) Filed: Aug. 15, 2012

(30) Foreign Application Priority Data
Sep. 26, 2011 (KR) 10-2011-0096812

(51) Int. Cl. B05B 1/14

(52) U.S. Cl. 239/558

(57) ABSTRACT

A nozzle for a burner boom water spray system of an offshore plant that can more efficiently shield a high heat source generating when combusting gas generating upon drilling crude oil is provided. The nozzle includes: a front ejecting portion having a first nozzle tap at the center; a first side ejecting portion formed at a lower side of the front ejecting portion; a second side ejecting portion formed at a lower side of the first side ejecting portion; and a fastening portion formed at a lower side of the second side ejecting portion and coupled to a member for supplying a nozzle injection fluid. The nozzle provides a side ejecting portion of two stages in addition to a front ejecting portion, and thus an efficient water curtain pattern can be embodied.

### TECHNICAL FIELD

The present invention relates to a nozzle for a burner boom water spray system of an offshore plant, and more particularly, to a nozzle for a burner boom water spray system of an offshore plant that can more efficiently shield a high heat source generating when combusting gas generating upon drilling crude oil.

### BACKGROUND ART

In general, because an offshore plant formed in a fixed type, a floating type, or a flexible type structure has been operated for about 3 years to 30 years after being installed at an oil or gas mining point, unlike a general ship, consideration conditions in view of a design are considerably complicated, and technology having various and high difficulty related to stability security for fire and explosion due to a production of petroleum products as well as a climate influence such as a wind or a wave and a special environmental situation of sea is requested.

Nowadays, due to demand increase for petroleum resource development in a deep sea area of 1,000 m or more, security and development of related technology has been variously performed, instead of a simple purpose offshore plant of an existing single function, an interest in demand and development for a multipurpose offshore plant that can simultaneously perform drilling, production, storage, etc., has gradually increased.

At a present domestic infrastructure and technical level, offshore plant design technology for oil and gas resources and offshore plant technology for offshore space use having relatively high realization should be first secured, and because such technology has a common target of offshore plant engineering technology security, it is expected that a concentration degree and a ripple effect of technology investment are high.

Particularly, an offshore plant burner boom water spray system suggested in the present invention is a water fire extinguishing system of a burner boom for an offshore plant and is an equipment for protecting a body of a ship, an equipment, and a person from a high heat source generating when combusting gas generating upon drilling crude oil at the bottom of the sea using a high pressure of water (minute waterdrop, mist) radiated from a nozzle.

The burner boom water spray system is an equipment for protecting the body of a ship, an equipment, and a person from combustion of gas while performing an oil drilling operating and includes a nozzle for spraying minute water, a water curtain piping for forming a predetermined water curtain using water sprayed through the nozzle, and a pump.

In operation of the burner boom water spray system, when the pump is operated, water supplied through the piping is radiated to minute water through the nozzle, various forms of water curtains are formed according to a form of the nozzle or a structure of the piping at which the nozzle is disposed.

FIGS. 1 to 4 relate to nozzle related major prior art patent documents disclosed at the inside and outside of the country before application of the present invention, and FIG. 1 relates to a nozzle related invention disclosed at Patent Publication of Korean Patent Application No. 10-2009-0000991, FIG. 2 relates to a nozzle related invention disclosed at Patent Publication of Korean Utility Model Application No. 20-2001-0032477, FIG. 3 relates to a nozzle related invention disclosed at patent Publication of U.S. patent application Ser. No. 10/620,606, and FIG. 4 relates to a nozzle related invention disclosed at patent Publication of U.S. patent application Ser. No. 08/945569.

In more detail, FIG. 1 (Korean Patent Application No. 10-2009-0000991) relates to a multi-ejection nozzle, and by forming a separate extension portion between a lower nozzle cap and a lower end of a nozzle body, after inside space of the nozzle body is secured, upon ejecting, a foreign substance and minute dust included in water are partially ejected and discharged through a side nozzle cap, and the remaining residual minute dust and foreign substance are ejected and discharged through the lower nozzle cap and thus even when a multi-ejection nozzle is used for a long term, a clogging phenomenon of a nozzle is prevented.

Next, FIG. 2 (Korean Utility Model Application No. 20-2001-0032477) relates to a minute spray nozzle of a fire extinguisher, and by injecting a screw type orifice into a nozzle tip, water injected into a vortex chamber is sprayed to a radial opening while causing a vortex phenomenon and thus water particles can be more minutely and evenly scattered.

Next, FIG. 3 (U.S. patent application Ser. No. 10/620,606) relates to a water spray head for spraying water in a fire prevention system, and an invention of FIG. 3 relates to a spray head apparatus including a water supply pipe; a spray head on a body; a fluid chamber, and a w-shaped lower portion and having nozzles forming at least two circles.

Finally, FIG. 4 (U.S. patent application Ser. No. 08/945569) relates to a nozzle method of a portable fire extinguisher, and a head has a plurality of nozzles separated from a front surface of a nozzle head while being connected to a supply pipe, and when a fire extinguishing liquid is supplied, each nozzle generates the mist of a fire extinguishing liquid.

However, in most of such nozzles disclosed at the prior art, a shape of a hole formed in a nozzle tap has a conventional form, and in order to perform a water curtain function, a plurality of nozzle taps disposed at a side surface thereof are also formed in a conventional form and thus there is a defect that an efficient water curtain function is not performed.

### DISCLOSURE

### Technical Problem

The present invention has been made in view of the above problems, and provides a nozzle for a burner boom water spray system of an offshore plant having a nozzle tap of an improved ejection efficiency instead of a conventional nozzle tap.

The present invention further provides a nozzle for a burner boom water spray system of an offshore plant in which a plurality of nozzle taps are disposed in a two-stage form at a side surface of a nozzle in order to efficiently form a water curtain.

### Technical Solution

In accordance with an aspect of the present invention, a nozzle for a burner boom water spray system of an offshore plant includes: a front ejecting portion having a first nozzle tap at the center; a first side ejecting portion formed at a lower side of the front ejecting portion and in which a plurality of second nozzle taps are disposed at a side surface at a predetermined gap; a second side ejecting portion formed at a lower side of the first side ejecting portion and in which a plurality of third nozzle taps are disposed at a side surface at a predetermined gap; and a fastening portion formed at a lower side of the second side ejecting portion and coupled to a member for supplying a nozzle injection fluid.

Preferably, each side surface of the first side ejecting portion and the second side ejecting portion is inclined by a predetermined angle from an upper end to a lower end thereof.

Preferably, horizontal cross-sections of the first side ejecting portion and the second side ejecting portion are a ring shape and have the same size, but may be partially changed.

Preferably, the plurality of second nozzle taps and the plurality of third nozzle taps are alternately disposed with an alternate arrangement method.

Preferably, the plurality of second nozzle taps are coupled to a plurality of tap holes, respectively, formed at a side surface of the first side ejecting portion, and the plurality of third nozzle taps are coupled to a plurality of tap holes, respectively, formed at a side surface of the second side ejecting portion.

Preferably, in a front central portion of each of the plurality of second nozzle taps and third nozzle taps, a hole for ejecting a fluid injected through each corresponding tap hole and a vertical circular arc type injection groove of a veejet spray nozzle type enclosing the hole are formed, and the vertical circular arc type injection groove of a veejet spray nozzle type is obliquely cut about the hole.

Preferably, the vertical circular arc type injection groove of a veejet spray nozzle type formed in the plurality of second nozzle taps and third nozzle taps obliquely installs the nozzle of a horizontal state in a range of 5° to 20°, but may be variously changed according to a tilt degree of a tap hole.

### Advantageous Effects

When using a nozzle for a burner boom water spray system of an offshore plant suggested in the present invention, the following effect is obtained.

The nozzle for a burner boom water spray system of an offshore plant according to the present invention provides a side ejecting portion of two stages in addition to a front ejecting portion, and thus an efficient water curtain pattern can be embodied, and by forming a vertical circular arc type injection groove of a veejet spray nozzle type in a nozzle tap, a spray range of a fluid ejected through the nozzle tap can be enlarged and thus a high heat radiated from gas generating upon performing a drilling operation can be effectively intercepted.

### DESCRIPTION OF DRAWINGS

FIGS. 1 to 4 are views illustrating conventional nozzles disclosed at domestic and foreign patent documents.

FIGS. 5 to 14 are views illustrating a nozzle for a burner boom water spray system of an offshore plant according to an exemplary embodiment of the present invention; and

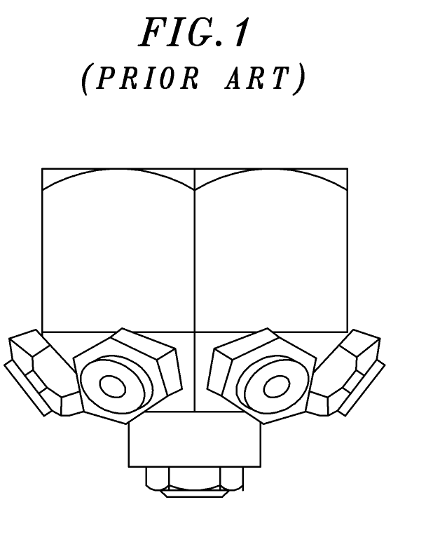

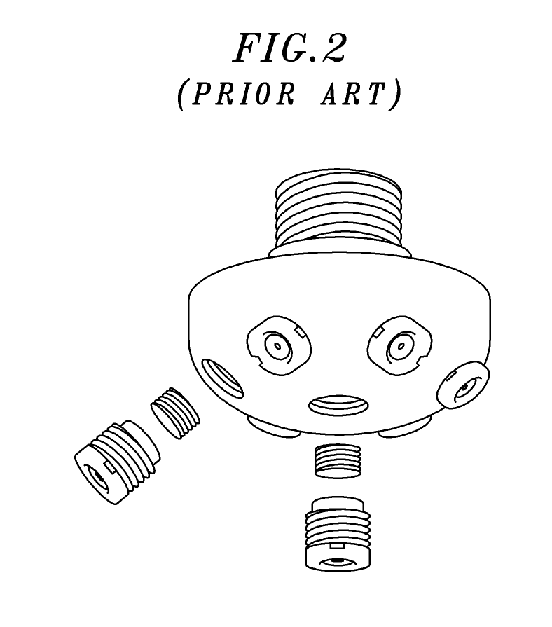

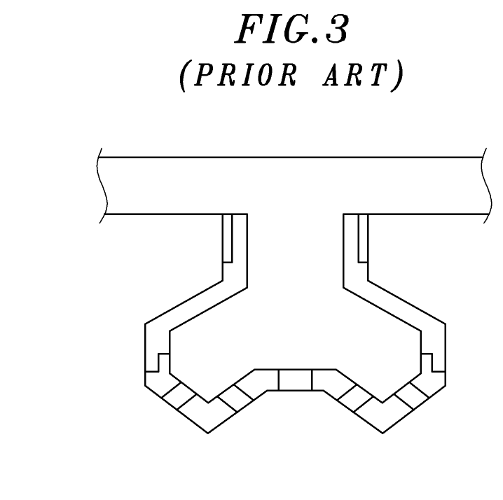

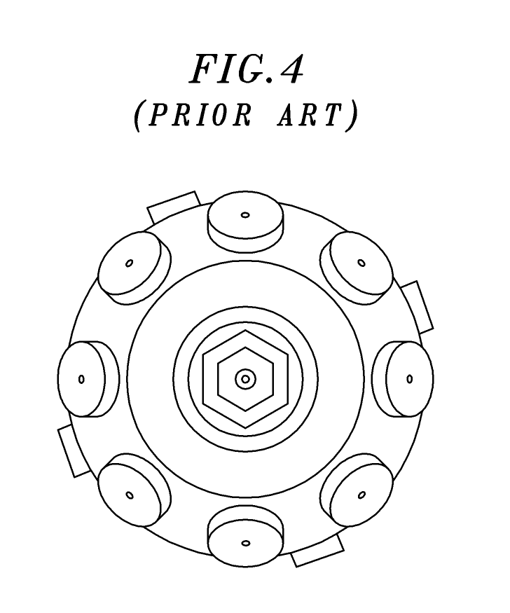

### BEST MODE

Before describing in detail a nozzle for a burner boom water spray system of an offshore plant suggested in the present invention, the present invention can be variously changed and may have various exemplary embodiments, and specific exemplary embodiments will be described in detail with reference to the drawings.

Hereinafter, a nozzle for a burner boom water spray system of an offshore plant according to an exemplary embodiment of the present invention will be described with reference to the drawings.

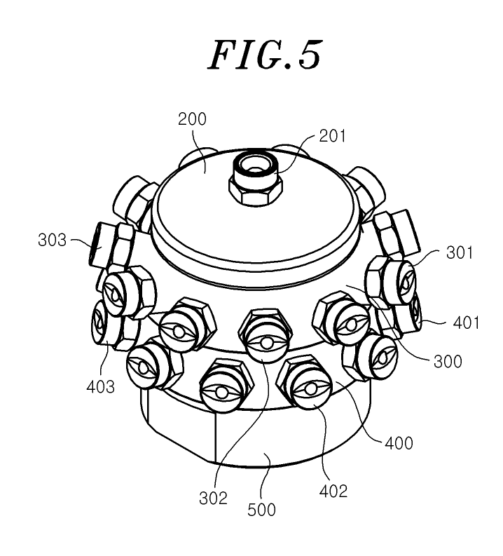

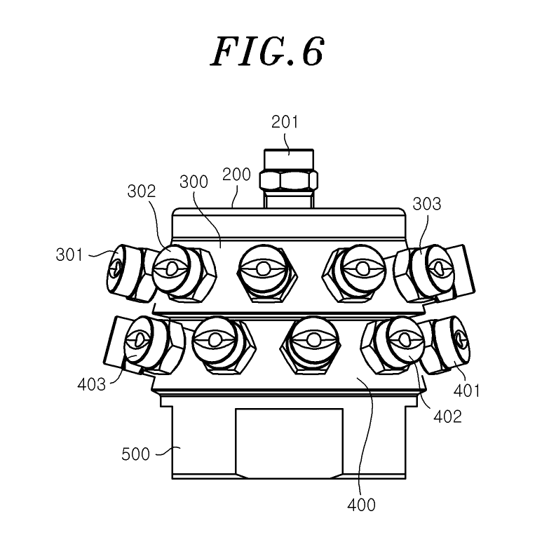

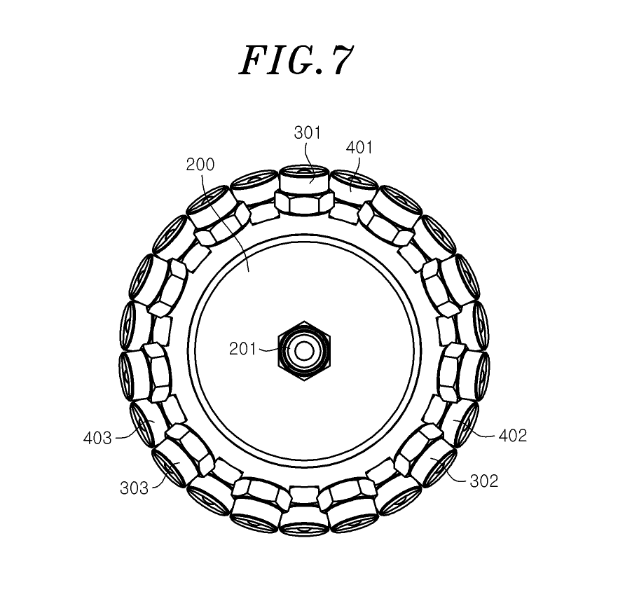

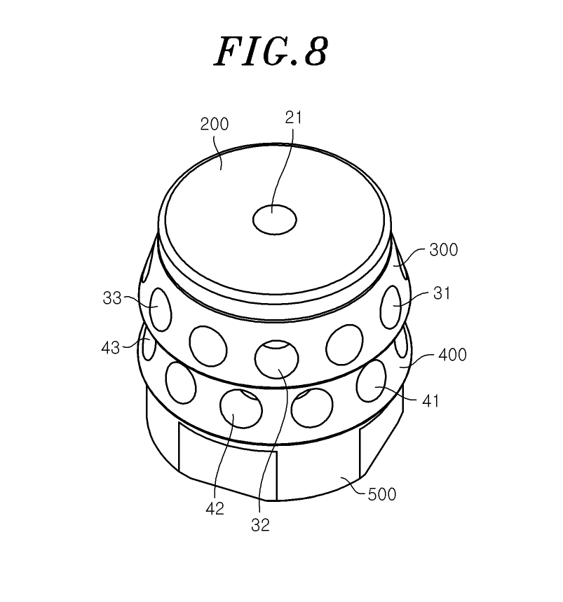

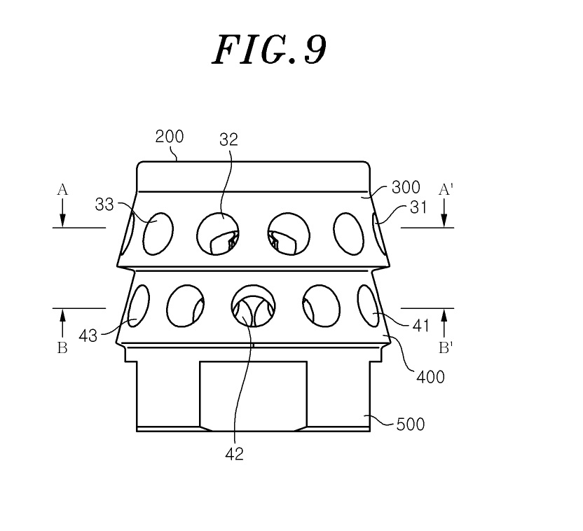

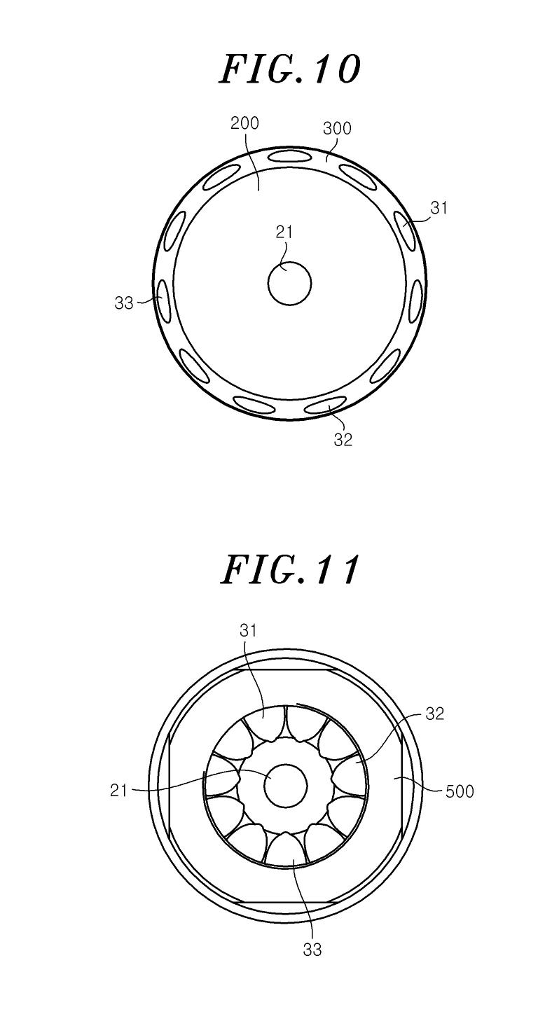

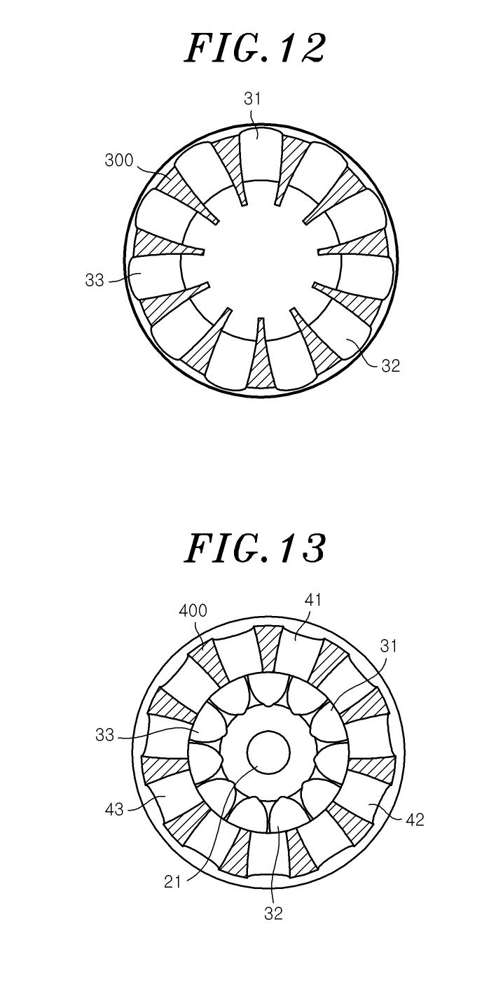

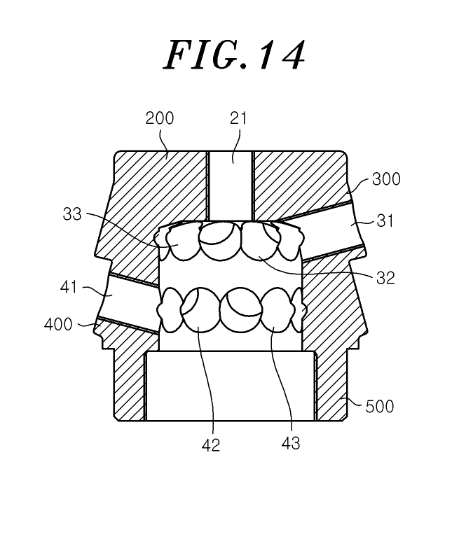

FIGS. 5 to 14 are views illustrating a nozzle for a burner boom water spray system of an offshore plant according to an exemplary embodiment of the present invention; specifically, FIG. 5 is a perspective view illustrating an external appearance of a nozzle for a burner boom water spray system of an offshore plant according to an exemplary embodiment of the present invention, FIG. 6 is a front view illustrating the nozzle shown in FIG. 5, FIG. 7 is a top plan view illustrating the nozzle shown in FIG. 5, FIG. 8 is a perspective view illustrating an external appearance of a state in which a nozzle tap is removed from the nozzle shown in FIG. 5, FIG. 9 is a front view illustrating the nozzle shown in FIG. 8, FIG. 10 is a top plan view illustrating the nozzle shown in FIG. 8, FIG. 11 is a bottom view illustrating the nozzle shown in FIG. 10, FIG. 12 is a horizontal cross-sectional view illustrating the nozzle taken along line A-A′ of FIG. 9, FIG. 13 is a horizontal cross-sectional view illustrating the nozzle taken along line B-B′ of FIG. 9, FIG. 14 is a vertical cross-sectional view illustrating the nozzle shown in FIG. 9.

As shown in FIGS. 5 to 7, a nozzle for an offshore plant burner boom water spray system according to an exemplary embodiment of the present invention includes a front ejecting portion 200, a first side ejecting portion 300, a second side ejecting portion 400, and a fastening portion 500.

The front ejecting portion 200 of a circular plate shape is positioned at the top end of the nozzle, and a nozzle tap 201 for ejecting fluid (e.g., water) is mounted at the center thereof.

The first side ejecting portion 300 is formed at the lower side of the front ejecting portion 200, and a plurality of nozzle taps 301, 302, 303 are disposed at a side surface at a predetermined gap.

The plurality of nozzle taps 301, 302, 303 are coupled to tap holes 31, 32, 33 formed in the first side ejecting portion 300, as shown in FIG. 8. As a coupling method, a screw coupling method is preferable, and a nut may be incidentally used. Further, upon coupling, in order to fill a gap, a seal resin may be used.

Next, the second side ejecting portion 400 is formed at the lower side of the first side ejecting portion 300, and a plurality of nozzle taps 401, 402, 403 are disposed at a predetermined gap at a side surface of the first side ejecting portion 300, as shown in the drawings.

As described above, as shown in FIG. 8, a plurality of nozzle taps 401, 402, 403 are coupled to tap holes 41, 42, 43 formed in the second side ejecting portion 400. As a coupling method, a screw coupling method is preferable and a nut may be incidentally used, and upon coupling, in order to fill a gap, a sealing resin may be used.

Each side surface of the first side ejecting portion 300 and the second side ejecting portion 400 is obliquely formed by a predetermined angle from an upper end to a lower end, and a horizontal section thereof has the same size in a ring shape, but a tilt angle or size may be changed, as needed.

For reference, a side tilt angle of the first and second side ejecting portions 300 and 400 forms an efficient water curtain pattern and may be variously designed according to a formed tilt of tap holes 31, 32, 33, 41, 42, 43 (see FIGS. 8 to 11) to which each of the nozzle taps 301, 302, 303, 401, 402, 403 is coupled.

As shown in the drawing, in a front central portion of each of a plurality of nozzle taps 301, 302, 303, 401, 402, 403 according to an exemplary embodiment of the present invention, holes for ejecting a fluid injected through corresponding tap holes 31, 32, 33, 41, 42, 43 and vertical circular arc type injection grooves of a veejet spray nozzle type enclosing the hole are formed.

The vertical circular arc type injection groove of a veejet spray nozzle type is obliquely cut about the hole. More specifically, the vertical circular arc type injection groove is obliquely cut toward a center-line from an outer circumferential edge of a pupil shape based on the center-line crossing the hole.

The reason of forming a vertical circular arc type injection groove of a veejet spray nozzle type is that an efficient water curtain pattern can be formed more than a case where a vertical circular arc type injection groove of a veejet spray nozzle type is not formed, and as an experiment result of several times, it is preferable that a vertical circular arc type injection groove of a veejet spray nozzle type obliquely installs the nozzle of a horizontal state in a range of 5° to 20° (see FIG. 15).

Finally, the fastening portion 500 coupled to a member for supplying a nozzle injection fluid and for guiding flow of a fluid (e.g., water) is formed at a lower side of the second side ejecting portion 400.

FIGS. 8 to 11 are an external appearance view, a front view, a top plan view, and a bottom view of a nozzle in which the nozzle taps 201, 301, 302, 303, 401, 402, 403 described in FIGS. 5 to 7 are removed.

As shown in FIGS. 8 to 11, a tap hole 21 is formed at the center of the front ejecting portion 200, a plurality of tap holes 31, 32, 33 are formed at a side surface of the first side ejecting portion 300, and a plurality of tap holes 41, 42, 43 are formed at a side surface of the second side ejecting portion 400.

The tap holes 21, 31, 32, 33, 41, 42, 43 are penetrating holes connected to the inside of the nozzle, and a fluid injected through an opening formed at the bottom of the fastening portion 500 passes through the tap holes 21, 31, 32, 33, 41, 42, 43 and is ejected through the nozzle taps 201, 301, 302, 303 401, 402, 403 corresponding thereto.

FIGS. 11 to 14 are a horizontal cross-sectional view and a vertical cross-sectional view of the first side ejecting portion 300 and the second side ejecting portion of the nozzle shown in FIG. 9.

As shown in FIGS. 12 and 13, a penetrating length of the tap holes 31, 32, 33 formed in the first side ejecting portion 300 is formed longer than a penetrating length of the tap holes 41, 42, 43 formed in the second side ejecting portion 400. This is to more efficiently transfer fluid injected through an opening formed at a bottom surface of the fastening portion 500 to the first side ejecting portion 300.

Further, the tap holes 31, 32, 33 formed in the first side ejecting portion 300 and the tap holes 41, 42, 43 formed in the second side ejecting portion 400 are positioned with an alternate arrangement method, i.e., a zigzag method. This is to reduce a so-called dead zone area that is not covered by a water curtain pattern formed by the first side ejecting portion 300 by making a difference between a water curtain pattern formed by a fluid ejected through the first side ejecting portion 300 and a water curtain pattern formed by a fluid ejected through the second side ejecting portion 400.

That is, in the present invention, by disposing the side ejecting portions 300 and 400 in two stages in order to improve a problem of a conventional general nozzle having only a side ejecting portion of one stage, a more efficient water curtain pattern can be formed and a dead zone area can be reduced more efficiently than a conventional nozzle having only a side ejecting portion of one stage.

As described above, the nozzle for a burner boom water spray system of an offshore plant according to the present invention can embody an efficient water curtain pattern by providing a side ejection portion of two stages in addition to a front ejection portion, and by forming a vertical circular arc type injection groove of a veejet spray nozzle type in a nozzle tap, a scattering range of a fluid ejected through the nozzle tap can be enlarged and thus a high heat radiated from a gas generating at a drilling operation can be efficiently intercepted.

A technical characteristic of a nozzle of the present invention relates to improvement of a function of a nozzle tap disposed as two stages and a hole formed in the nozzle tap, and it should be clearly understood that many variations and modifications of the present invention will still fall within the spirit and scope of the exemplary embodiments of the present invention as defined in the appended claims.

### DESCRIPTION OF REFERENCE NUMERALS

200: front ejecting portion

201: nozzle tap

300: first side ejecting portion

301, 302, 303: nozzle tap

31, 32, 33: tap hole

400: second side ejecting portion

401, 402, 403: nozzle tap

41, 42, 43: tap hole

500: fastening portion

1. A nozzle for a burner boom water spray system of an offshore plant, the nozzle comprising:
a front ejecting portion having a first nozzle tap at the center;
a first side ejecting portion formed at a lower side of the front ejecting portion and in which a plurality of second nozzle taps are disposed at a side surface at a predetermined gap;
a second side ejecting portion formed at a lower side of the first side ejecting portion and in which a plurality of third nozzle taps are disposed at a side surface at a predetermined gap; and
a fastening portion formed at a lower side of the second side ejecting portion and coupled to a member for supplying a nozzle injection fluid.

2. The nozzle of claim 1, wherein each side surface of the first side ejecting portion and the second side ejecting portion is inclined by a predetermined angle from an upper end to a lower end thereof.

3. The nozzle of claim 2, wherein horizontal cross-sections of the first side ejecting portion and the second side ejecting portion are a ring shape and have the same size.

4. The nozzle of claim 1, wherein the plurality of second nozzle taps and the plurality of third nozzle taps are alternately disposed with an alternate arrangement method.

5. The nozzle of claim 1, wherein the plurality of second nozzle taps are coupled to a plurality of tap holes, respectively, formed at a side surface of the first side ejecting portion, and
the plurality of third nozzle taps are coupled to a plurality of tap holes, respectively, formed at a side surface of the second side ejecting portion.

6. The nozzle of claim 5, wherein in a front central portion of each of the plurality of second nozzle taps and third nozzle taps, a hole for ejecting a fluid injected through each corresponding tap hole and a vertical circular arc type injection groove of a veejet spray nozzle type enclosing the hole are formed, and
the vertical circular arc type injection groove of a veejet spray nozzle type is obliquely cut about the hole.

7. The nozzle of claim 6, wherein the vertical circular arc type injection groove of a veejet spray nozzle type formed in the plurality of second nozzle taps and third nozzle taps obliquely installs the nozzle of a horizontal state in a range of 5° to 20°.
